(19) United States
(12) Patent Application Publication
(10) Pub. No.: US 2016/0065689 A1
(43) Pub. Date: Mar. 3, 2016

(54) CACHE CONTROL DEVICE AND CACHE CONTROL METHOD

(71) Applicant: FUJITSU LIMITED, Kawasaki-shi (JP)

(72) Inventor: Satoshi IMAI, Kawasaki (JP)

(73) Assignee: FUJITSU LIMITED, Kawasaki-shi (JP)

(21) Appl. No.: 14/812,175

(22) Filed: Jul. 29, 2015

(30) Foreign Application Priority Data
Aug. 28, 2014 (JP) 2014-173516

(51) Int. Cl. H04L 29/08; H04L 12/721

(52) U.S. Cl. CPC H04L 67/2842; H04L 45/12

(57) ABSTRACT

A cache control device includes: a processor to execute a procedure including: collecting request information indicating an amount of request received by each of nodes from outside of a system; estimating a propagation amount of the request transferred within the system due to a cache miss based on the request information, an initial TTL value set in nodes indicating a time during which data is stored in a cache memory, and delivery tree root information indicating a delivery tree route; estimating a total cost for storing and delivering data corresponding to the request based on the propagation amount of the request estimated, memory cost information indicating a cost required for storing and delivering a predetermined amount of data, and delivery cost information indicating a cost required for transferring the predetermined amount of data; and updating the initial TTL value so as to reduce the total cost estimated.

### CROSS-REFERENCE TO RELATED APPLICATION

This application is based upon and claims the benefit of priority from the prior Japanese Patent Application No. 2014-173516 filed on Aug. 28, 2014, the entire contents of which are incorporated herein by reference.

### FIELD

The embodiments discussed herein are related to a cache control device and a cache control method that control a cache memory disposed in a plurality of nodes within a network.

### BACKGROUND

An in-network caching system has been proposed as a technology for reducing the amount of traffic to allow the content data to be efficiently delivered. In the in-network caching system, a copy of the content data is stored in a single or a plurality of cache servers on the network and the content is delivered from the cache server located in the vicinity of a user.

In the in-network caching system, the traffic amount to be processed in the network becomes smaller as the copy of the content data is stored in more cache servers. As a result, the cost for a traffic delivery (traffic delivery cost) (e.g., bandwidth use amount) is reduced. However, when the copy of the content data is stored in many cache servers, for example, since the memory capacity of each cache server is required to be increased, the cost accompanying the memory use (memory use cost) increases. Therefore, it is required to take both of the traffic delivery cost and the memory use cost into account in order to reduce the cost of the entire network.

In recent years, a technology (e.g., NFV: Network Function Virtualization) is drawing attention in which a virtual network is constructed from physical network resources and required resources are allocated to a node and a link that constitute the virtual network. Further, as an application implemented on the NFV platform, a technology (e.g., CCN: Content Centric Networking) is known that provides a cache function to each node so as to alleviate the constraints of a cache disposition of the content. In the virtual network to which the CCN is applied, a delivery tree is automatically constructed in such a way that a topmost node at which a server for delivering the content exists is set as a root node and a plurality of cache nodes are hierarchically connected with each other from the root node.

Each cache node on the delivery tree determines whether the content data corresponding to a request received from a user is stored in its cache. Also, when it is determined that the content data corresponding to the request is stored in its cache (hereinafter, may be referred to as a cache hit), the cache node delivers the content data to the user. In the meantime, when the content data corresponding to the request is not stored in the cache memory (hereinafter, may be referred to as a cache miss), the cache node transfers the request to an upper level node of the delivery tree. Also, the cache node delivers the content data received from the upper level node to the user. In this case, the cache node stores the content data received from the upper level node in a cache memory within its own node. However, in the hierarchically distributed cache system described above, the traffic delivery amount and the cache use efficiency vary depending on a storing situation of the content data, e.g., what kind of content data is stored in which node.

In the meantime, a technology is known in which useless data is deleted in the cache node using the lifespan of data (TTL: Time-To-Live) in the related art. In this case, the cache node deletes the content for which the request is not received within a TTL period. Here, when a value of TTL is large, since the probability that the content data is stored in each cache node is higher, the data is delivered starting from the cache node disposed nearer to the user. Accordingly, although the traffic amount within the network is reduced, the memory use amount is increased in each cache node. In the meantime, when the value of TTL is small, the probability of an occurrence of the cache miss becomes higher. When the cache miss occurs, a processing of transferring the request to the upper level node is required and a route along which the content is delivered becomes longer and thus, the traffic delivery cost becomes higher.

As described above, there is a tradeoff relationship between the traffic delivery cost and the memory use cost with respect to the TTL value.

In the meantime, a method of determining the TTL in the cache node is described in, for example, Japanese Laid-Open Patent Publication No. 2004-295845 and Japanese Laid-Open Patent Publication No. 2012-212208 (Japanese Patent No. 5348167).

Related technologies are disclosed in, for example, Japanese Laid-Open Patent Publication No. 2004-295845 and Japanese Laid-Open Patent Publication No. 2012-212208 (Japanese Patent No. 5348167).

### SUMMARY

According to an aspect of the invention, a cache control device includes: a processor configured to execute a procedure, the procedure including: collecting request information for indicating an amount of request received by each of a plurality of nodes from outside of a distributed cache system in which a cache memory is provided in each of the plurality of nodes hierarchically connected with each other and the request is transferred to an upper level node of a delivery tree route in the plurality of nodes when a cache miss occurs for the request; estimating, by a request propagation estimation unit, a propagation amount of the request transferred within the distributed cache system due to the cache miss based on the request information, an initial TTL (Time-To-Live) value set in the plurality of nodes indicating a time during which data is stored in the cache memory, and delivery tree root information for indicating the delivery tree route; estimating, by a cost estimation unit, a total cost for storing and delivering data corresponding to the request based on the propagation amount of the request estimated by the request propagation estimation unit, memory cost information for indicating a cost required for storing and delivering a predetermined amount of data, and delivery cost information for indicating a cost required for transferring the predetermined amount of data; and updating, by a TTL determination unit, the initial TTL value so as to reduce the total cost estimated by the cost estimation unit, wherein the cache control device and the plurality of nodes are included in the distributed cache system.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are diagrams illustrating an example of a network over which a distributed cache system is operated;

FIG. 2 is a diagram illustrating an example of a configuration of a node device;

FIGS. 3A and 3B are diagrams illustrating an embodiment of a cache control method;

FIG. 4 is a block diagram illustrating functionalities of a cache control device;

FIG. 5 is a diagram for explaining a total cost;

FIG. 6 is a flowchart illustrating a process performed in the cache control method;

FIG. 7 is a diagram illustrating an example of a hardware configuration of the cache control device;

FIG. 8 is a diagram illustrating an example of estimated request propagation;

FIG. 9 is a diagram for explaining a delivery cost;

FIG. 10 is a diagram illustrating an example of an embodiment of a computation of estimating the request propagation;

FIG. 11 is a diagram illustrating a relationship between an initial TTL value and a total cost;

FIG. 12 is a diagram illustrating a model of simulation by which the initial TTL value is derived;

FIG. 13 is a diagram illustrating simulation results by a sweep search;

FIG. 14 is a diagram illustrating simulation results by an online search;

FIG. 15 is a diagram for explaining a method of determining the initial TTL value by other embodiment; and

FIG. 16 is a diagram illustrating a sequence of determining the initial TTL value by other embodiment.

### DESCRIPTION OF EMBODIMENTS

A Time-To-Live (TTL) value set in a cache node needs to be appropriately determined in order to reduce the total cost which includes a traffic delivery cost and a memory use cost. In the meantime, in a hierarchically distributed cache system, when a cache miss occurs with respect to a certain request, the request is transferred to an upper level node. Therefore, the performance of a content cache, which caches the entirety of data to be transmitted and received among the data travelling over a cache network path at Layer 7, of each cache node affects the upper level node, thereby making it difficult to specify the contribution of TTL to a total cost for the entire network. That is, in the relate art, it is not easy to compute and reduce the total cost for the entire network.

Hereinafter, descriptions will be made on a technology of reducing the total cost for the entire network in the hierarchically distributed cache system with reference to the accompanying drawings.

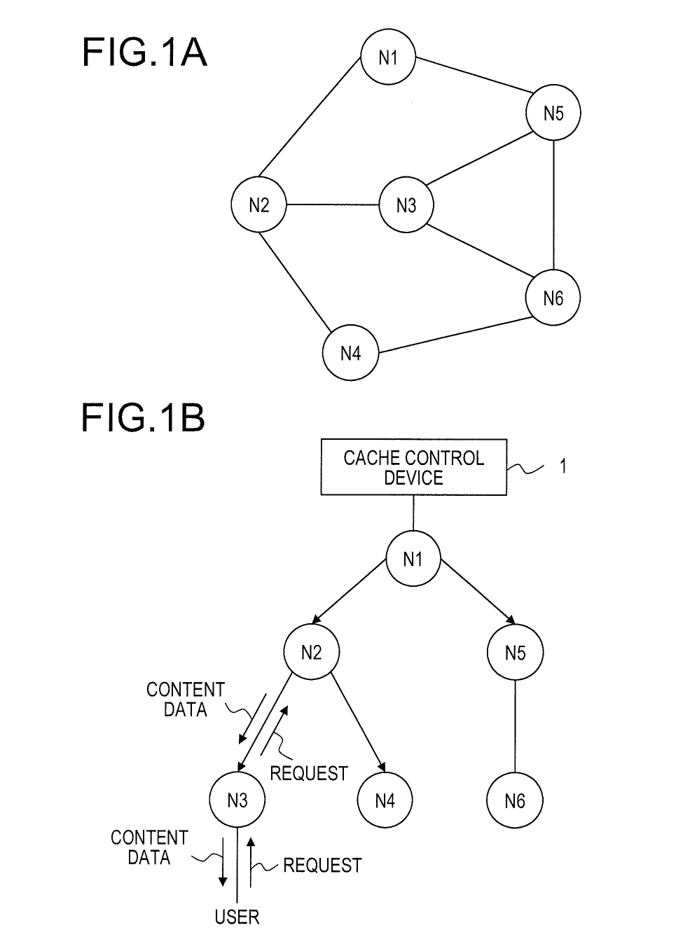

FIGS. 1A and 1B illustrate an example of a network over which a distributed cache system is operated. As illustrated in FIG. 1A, the network includes a plurality of nodes N1, N2, N3, N4, N5, and N6. Each of the nodes N1 to N6 is provided with a data communication device such as a switch or a router. In the following description, the data communication device provided in each node may be referred to as a “node device” or simply a “node”.

Each node is connected to a single node or a plurality of other nodes through a physical link. In the meantime, a solid line connecting the nodes with each other indicates the physical link in FIG. 1A. For example, the node N3 is connected to the nodes N2, N5, and N6 through the physical link. The physical link is, for example, an optical fiber. Otherwise, the physical link may be a wireless link. Each of the nodes N1 to N6 may accommodate a user and may be connected with other network.

When a request for requesting a delivery of content is received from the user, the node device provides the user with content data corresponding to the request. Here, a cache memory is provided in each node. Also, when the requested content is stored in the cache of its own node, the node device transmits the content data to the user. In the meantime, when the requested content is not stored in the cache of its own node, the node device transfers the received request to other node. A transfer destination of the request is designated in accordance with the delivery tree prepared in advance.

FIG. 1B illustrates an example of the distributed cache system configured on the physical network illustrated in FIG. 1A. The distributed cache system is implemented by a virtual network which provides the delivery tree prepared in advance. A route along which the content is delivered is designated based on the delivery tree. In the meantime, in an example illustrated in FIG. 1B, the original copy of the content data is assumed to be stored in the content server connected to the node N1. In this case, the node N1 may be referred to as a “root node.”

In the distributed cache system having the configuration described above, when the cache miss occurs, the received request is transferred to an upper level node of the delivery tree. For example, when the cache miss occurs in the node N3, the received request is transferred from the node N3 to the node N2. Here, when the content data corresponding to the request is stored in the node N2, the content data is delivered from the node N2 to the node N3. Also, the content data is transferred from the node N3 to the user. In this case, a copy of the content data is stored in the cache of the node N3. In the meantime, when the content data corresponding to the request is not stored in the node N2, the request is further transferred from the node N2 to the node N1.

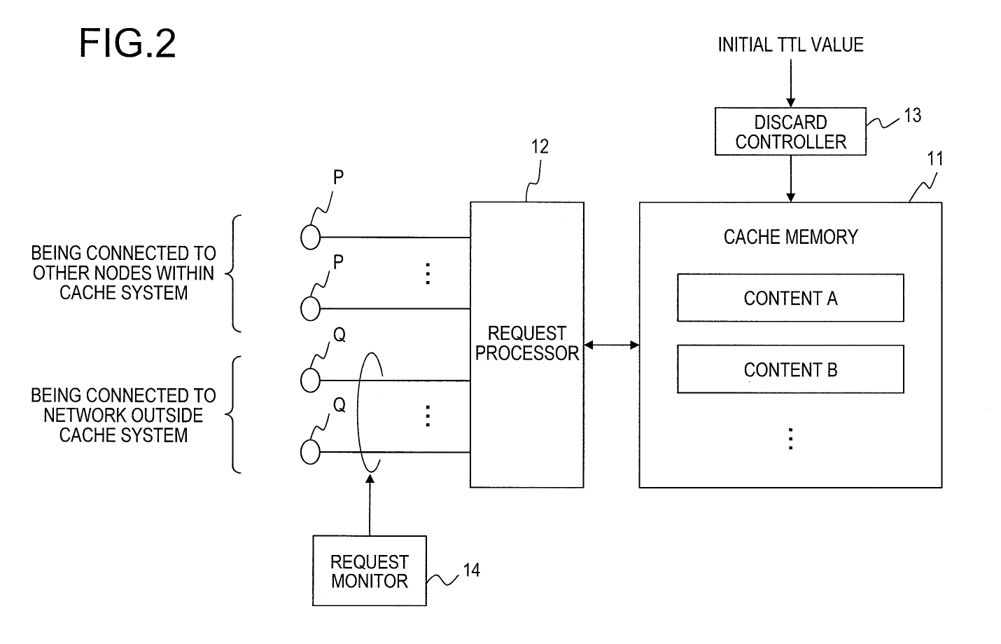

FIG. 2 illustrates an example of a configuration of a node device. The node device includes a communication port P, a communication port Q, a cache memory 11, a request processor 12, a discard controller 13, and a request monitor 14 as illustrated in FIG. 2. The communication port P is connected to other nodes within the distributed cache system. The communication port Q is connected to a network outside the distributed cache system. Specifically, the communication port Q is connected to, for example, the user.

The cache memory 11 may store the content data therein. In an example illustrated in FIG. 2, the contents (A, B, . . . ) are stored in the cache memory 11. The request processor 12 processes a content delivery request received through the communication port P or the communication port Q. That is, when the content data corresponding to the received content delivery request is stored in the cache memory 11, the request processor 12 delivers the content data to a transmission source of the request. In the meantime, when the content data corresponding to the received content delivery request is not stored in the cache memory 11, the request processor 12 transfers the request to an upper level node of the delivery tree.

The discard controller 13 discards the content data stored in the cache memory 11 according to the TTL value. The initial TTL value is given from a cache control device 1 which will be described later.

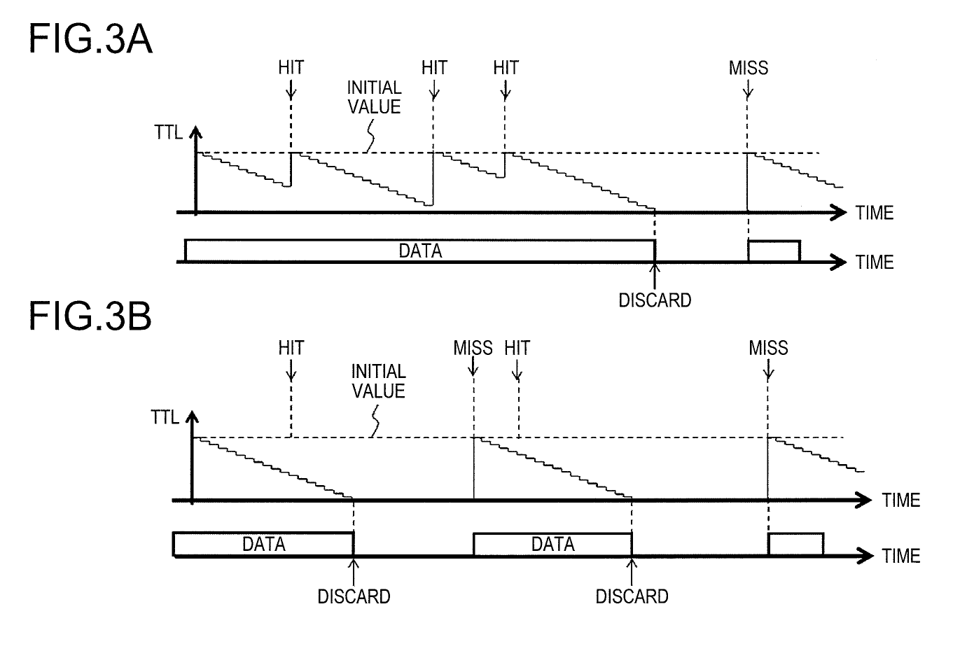

FIGS. 3A and 3B illustrate an embodiment of a cache control method. The data stored in the cache memory is managed using the TTL value. That is, when new data is stored in the cache memory, the TTL value corresponding to the data is set as an initial TTL value. The TTL value is decreased at a given rate according to the lapse of time. Also, when the TTL value becomes zero, the data stored in the cache memory is discarded.

In the policy 1 illustrated in FIG. 3A, when the cache hit occurs, the TTL value is updated with the initial TTL value. In this case, an estimated value of a cache hit ratio is expressed as a function “f” described in Equation (1).

ƒ(λ^{c},TTL^{c})=1−e^{-λ}^{^{c}}^{TTL}^{^{c}} (1)

The symbol “λ” indicates a request rate. The request rate indicates the number of requests received within a predetermined period of time. That is, in the policy 1, as the request rate “λ” becomes higher, the cache hit ratio becomes higher. Further, as the initial TTL value becomes higher, the cache hit ratio becomes higher as well. In the meantime, in the present example, the request rate “λ” and the initial TTL value are designated for each content. In Equation (1), the subscript “c” indicates that the request rate “λ” and the initial TTL value are designated for each content.

In the policy 2 illustrated in FIG. 3B, even when the cache hit occurs, the TTL value is not updated with the initial TTL value. In this case, the estimated value of the cache hit ratio is expressed as a function “f” described in Equation (2).

$$f ( {λ}^{c} , {TTL}^{c} ) = \frac{{λ}^{c} {TTL}^{c}}{1 + {λ}^{c} {TTL}^{c}} \qquad ( 2 )$$

In the meantime, in the following description, the discard controller 13 manages the cache memory 11 using, for example, the policy 1 illustrated in FIG. 3A. However, the present disclosure is not limited to the method described above. That is, the discard controller 13 may manage the cache memory 11 using the policy 2 illustrated in FIG. 3B.

The request monitor 14 monitors the number of requests received by the node device (e.g., the rate of received requests). However, the request monitor 14 counts the requests received from outside the distributed cache system. That is, the request monitor 14 does not count the requests transferred from other node within the distributed cache system. For example, the request monitor 14 counts the request received from the user in the node N3 illustrated in FIG. 1B. In the meantime, the request monitor 14 does not count the request transferred from the node N3 in the node N2. In the meantime, the request monitor 14 of each node monitors the request rate for each content.

The distributed cache system according to the embodiment includes a cache control device 1 as illustrated in FIG. 1B. Even though the cache control device 1 is provided in the root node (e.g., the node N1) in this example, the cache control device 1 may be provided in other node. Also, the cache control device 1 determines the initial TTL value of the cache memory to be set in each node for each content. In the present embodiment, the same initial TTL value is set in each node.

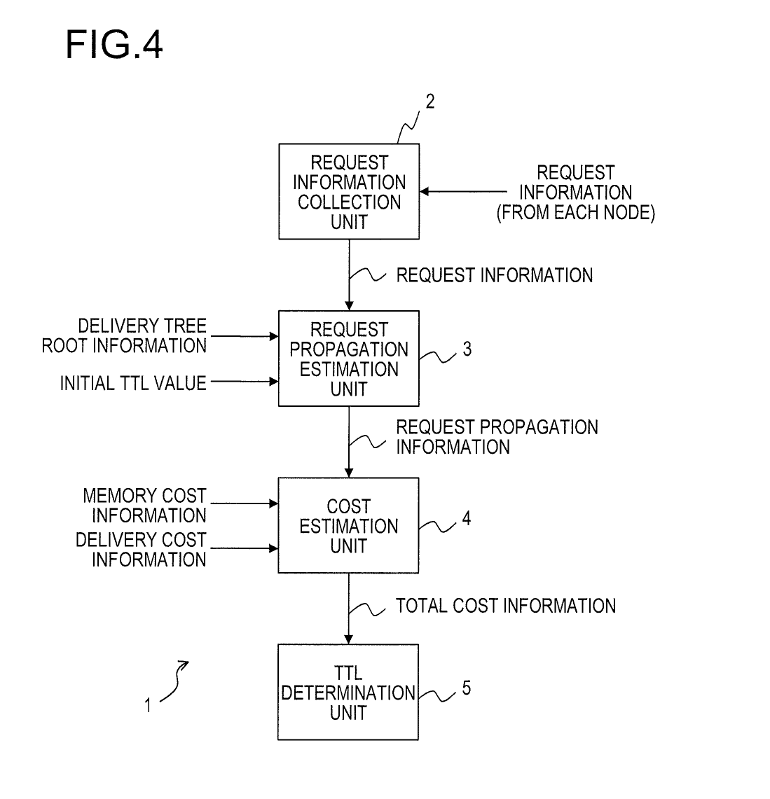

FIG. 4 is a block diagram illustrating functionalities of the cache control device 1. The cache control device 1 includes a request information collection unit 2, a request propagation estimation unit 3, a cost estimation unit 4, and a TTL determination unit. In the meantime, the cache control device 1 may have other functionalities that are not illustrated.

The request information collection unit 2 collects the request information indicating the rate of received requests measured by the request monitor 14 of each node. For example, the request information collection unit 2 collects the request information from each node regularly.

The request propagation estimation unit 3 estimates a propagation amount of the request transferred within the distributed cache system based on the request information collected by the request information collection unit 2, the initial TTL value set in each node, and the delivery tree root information. The delivery tree root information designates the route along which the content is delivered as described above. Further, the delivery tree root information is prepared in advance by, for example, the network manager. In the meantime, when the cache miss occurs in a certain node, the request is transferred to other node. That is, request propagation estimation unit 3 estimates the propagation amount of the request transferred within the distributed cache system due to the cache miss.

The cost estimation unit 4 estimates the total cost for storing and delivering the data corresponding to the request based on the request propagation information to indicate the propagation amount of the request estimated by the request propagation estimation unit 3, the reference memory cost information, and the reference delivery cost information. The reference memory cost information indicates a cost required for storing a predetermined amount of data and is predetermined according to, for example, a price of memory device. The reference memory cost is represented by, for example, “yen/bit.” The reference delivery cost information indicates a cost required for delivering a predetermined amount of data and is predetermined according to, for example, a communication charge. The reference delivery cost is represented by, for example, “yen/bit·hop length (hop count).”

The TTL determination unit determines the initial TTL value which reduces the total cost estimated by the cost estimation unit 4. That is, the TTL determination unit determines the initial TTL value so as to make the cost of the entire distributed cache system to be smaller than the total cost estimated by the cost estimation unit 4 (e.g., make the cost of the entire distributed cache system to become minimal).

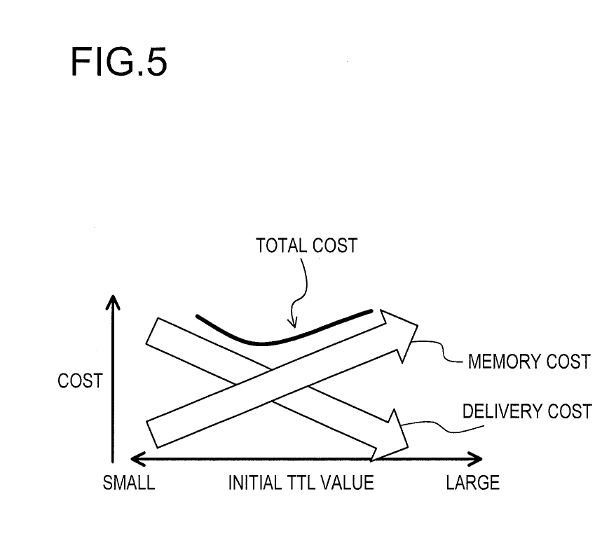

In the distributed cache system, the total cost for storing and delivering the content data is represented by a total of the memory cost and the delivery cost. Here, when the initial TTL value is large, a time during which the data is stored in the cache memory becomes longer. Accordingly, when the initial TTL value is large, the memory cost also becomes larger. And, when the initial TTL value is large, since the probability that data will be stored in the cache memory of the each node is high, the probability that data will be delivered to the node disposed nearer to the user. Accordingly, when the initial TTL value is large, the delivery cost becomes smaller. Accordingly, the total cost has a minimal value or a minimum value with respect to the initial TTL value as illustrated in FIG. 5. Accordingly, the TTL determination unit determines the initial TTL value so as to allow the total cost for storing and delivering the data to approach the minimal value or the minimum value. In the meantime, in the following description, the “minimal value” is assumed to include the “minimum value.”

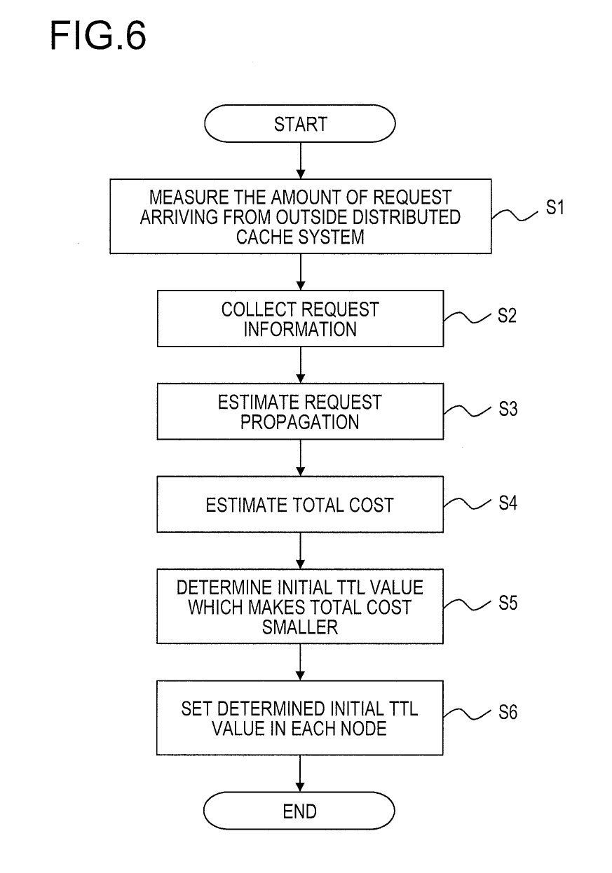

FIG. 6 is a flowchart illustrating a process performed in the cache control method according to an embodiment of the present disclosure. The process of the flowchart is regularly executed in, for example, the distributed cache system. Further, for example, the process of the flowchart is executed for each content.

At S1, the request monitor 14 of each node measures the request rate. In this case, the request monitor 14 counts the request received from outside the distributed cache system. Also, the request information indicating the measurement result of the request is transmitted from each node to the cache control device 1.

The processing at S2, S3, S4, and S5 are executed by the cache control device 1. That is, the request information collection unit 2 collects the request information from each node at S2. At S3, the request propagation estimation unit 3 estimates the propagation amount of the request to be transferred within the distributed cache system based on the request information, the current initial TTL value, and the delivery tree root information. At S4, the cost estimation unit 4 estimates the total cost for storing and delivering the data corresponding to the request based on the propagation amount of the request, the reference memory cost information, and the reference delivery cost information. At S5, the TTL determination unit determines the initial TTL value which reduces the total cost estimated by the cost estimation unit 4.

At S6, the cache control device 1 sets the initial TIL value determined at S2, S3, S4, and S5 in each node. Then, in each node, the discard controller 13 manages the cache memory 11 using the initial TTL value set by the cache control device 1. Specifically, a data discard process illustrated in FIG. 3A or FIG. 3B is performed using a new initial TTL value.

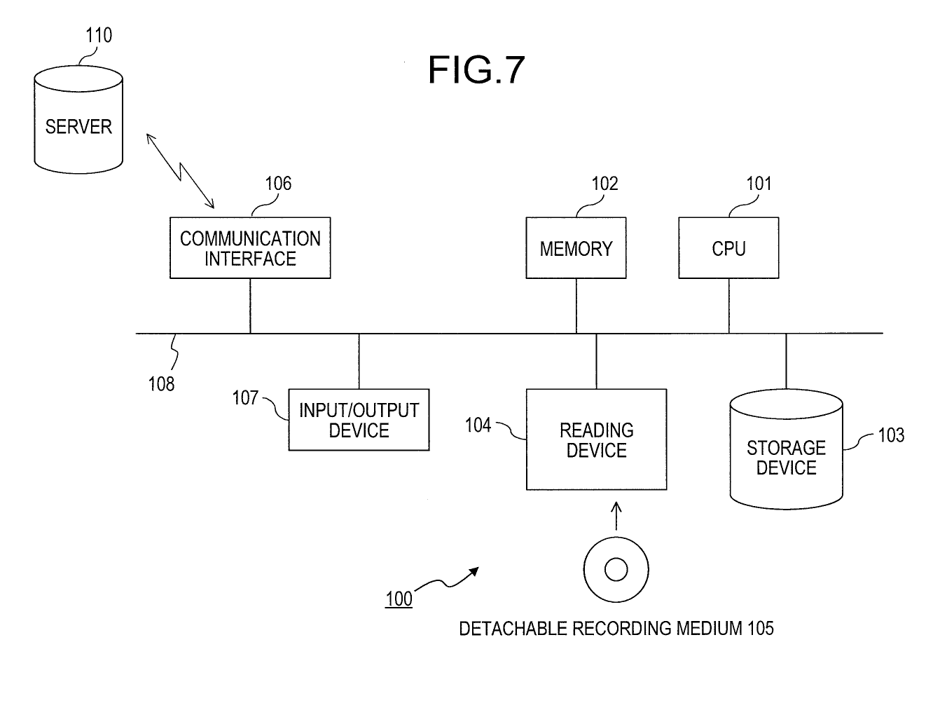

FIG. 7 illustrates an example of a hardware configuration of the cache control device 1. The cache control device 1 includes a computer system 100 illustrated in FIG. 7. The computer system 100 is provided with a CPU 101, a memory 102, a storage device 103, a reading device 104, a communication interface 106, and an input/output device 107. The CPU 101, the memory 102, the storage device 103, the reading device 104, the communication interface 106, and the input/output device 107 are connected with each other through, for example, a bus 108.

The CPU 101 executes a cache control program in which the processing performed at S2, S3, S4, and S5 of the flowchart illustrated in FIG. 6 are described using the memory 102. Accordingly, the functionalities of the request information collection unit 2, the request propagation estimation unit 3, the cost estimation unit 4, and the TTL determination unit illustrated in FIG. 4 are provided. That is, the cache control method described above is implemented. The memory 102 is, for example, a semiconductor memory and is configured to include a RAM area and a ROM area. The storage device 103 is, for example, a hard disk device and stores the cache control program described above. In the meantime, the storage device 103 may be a semiconductor memory such as a flash memory. Further, the storage device 103 may be an external storage device.

The reading device 104 accesses a detachable recording medium 105 according to an instruction of the CPU 101. The detachable recording medium 105 is implemented by, for example, a semiconductor device (e.g., USB memory), a medium (e.g., magnetic disk) in which information is input/output through a magnetic action, and a medium (e.g., CD-ROM and DVD) in which information is input/output through an optical action. The communication interface 106 may transmit and receive data through the network according to an instruction of the CPU 101. The input/output device 107 includes, for example, a device which receives an instruction from the user.

For example, the cache control program according to the embodiment is provided in the computer system 100 in the following manner. (1) The cache control program is pre-installed in the storage device 103. (2) The cache control program is provided by the detachable recording medium 105. (3) The cache control program is provided from a program server 110.

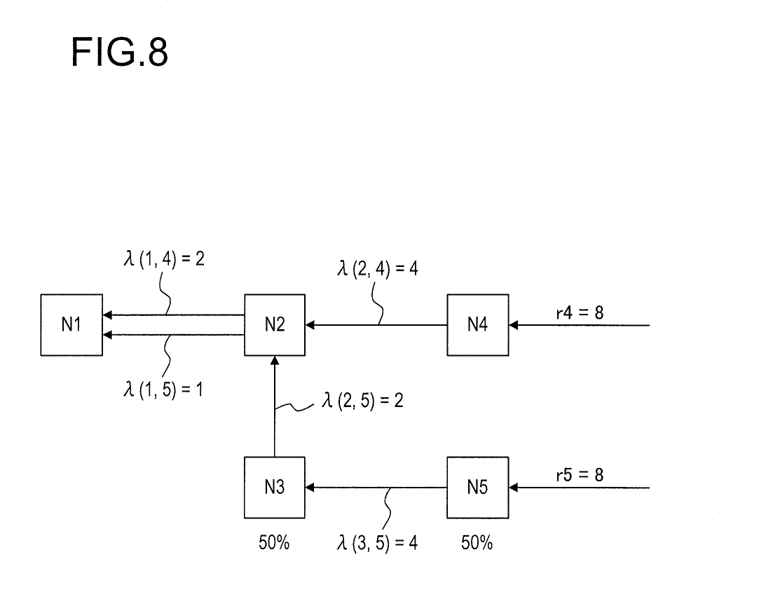

FIG. 8 illustrates an example of a request propagation to be estimated. In the present embodiment, the distributed cache system includes the node N1, N2, N3, N4, and N5. The node N1 is a root node and is connected to a content server. The node N2 is connected to the downstream of the node Ni. The node N3 and the node N4 are connected to the downstream of the node N2. The node N5 is connected to the downstream of the node N3. In the present example, for the purpose of simplifying the description, it is assumed that the estimated cache hit ratio in each node is 50% (percentage). That is, the estimated cache miss ratio in each node is 50%.

In the distributed cache system described above, it is assumed that the node N4 receives 8 (eight) requests from the user accommodated in the node N4 within a predetermined monitoring period. In this case, the rate of received requests “r4=8” may be obtained by the request monitor 14 of the node N4. In the meantime, in FIG. 8, the reference numeral “ri” indicates the rate of received requests for the requests received from outside of the distributed cache system in the node Ni.

Here, the estimated cache miss ratio in the node N4 is 50° A). That is, in the node N4, it is estimated that the cache miss occurs for four requests among eight received requests. Accordingly, it is estimated that four requests are transferred from the node N4 to the node N2. That is, a propagation request rate “λ(2,4)=4” may be obtained. In the meantime, in FIG. 8, the reference numeral “λ(x,i)” indicates that the propagation rate of requests to be transferred to a node Nx among the requests received in the node Ni.

The estimated cache miss ratio in the node N2 is also 50%. That is, in the node N2, it is estimated that the cache miss occurs for two requests among four requests received from the node N4. Accordingly, it is estimated that two requests out of four requests received from the node N4 are transferred from the node N2 to the node N1. That is, the propagation request rate “λ(1,4)=1” may be obtained.

Similarly, the following estimation results may be obtained for the requests received in the node N5. Four requests are transferred from the node N5 to the node N3 (“λ(3,5)=4”). Two requests are transferred from the node N5 to the node N2 via the node N3 (“λ(2,5)=2”). Also, one request is transferred from the node N5 to the node N1 via the node N3 and the node N2 (“λ(1,5)=1”).

The estimation described above is performed by the request propagation estimation unit 3 of the cache control device 1. That is, the request propagation estimation unit 3 estimates the propagation request rate between respective nodes based on the request information indicating the rate of received requests measured in each of the nodes N4 and N5. In the meantime, the request propagation estimation unit 3 performs the estimation described above for each content.

In the meantime, even though in the example described above, the cache hit ratio of each node is fixedly given, the cache hit ratio is estimated by the cache control device 1 (e.g., request propagation estimation unit 3) in reality. That is, the cache hit ratio of each node is estimated by, for example, Equation (1) described above.

For example, the cache hit ratio in the node N3 is calculated using Equation (1) based on the estimated request rate “λ(3,5)” and the current initial TTL value. Further, the cache hit ratio in the node N2 is calculated using Equation (1) based on the estimated request rate “λ(2,4)+λ(2,5)” and the current initial TTL value.

With this configuration, after the propagation of requests within the distributed cache system is estimated by the request propagation estimation unit 3, the cost estimation unit 4 estimates the total memory cost and the total delivery cost using the estimation results by the request propagation estimation unit 3. The total memory cost is a total of memory costs in each node. Also, the memory cost in each node is expressed by the following equation. The “memory cost=Costₛθ_{c}f” indicates the reference memory cost described above and is a constant given to the distributed cache system in advance. The “θ_{c}” indicates a data size of the content corresponding to the request. The “f” indicates a cache hit ratio and is estimated by, for example, Equation (1) described above. In the meantime, the cache hit ratio indicates the probability that the memory will be used by the target data. That is, the cache hit ratio indicates the probability that the target data is using the memory. Accordingly, the memory cost is proportional to the cache hit ratio in the present embodiment.

The “Costₛ” and “θₛ” are given values. Further, the function “f” which estimates the cache hit ratio is determined based on the estimated request rate and the current initial TTL value. The initial TTL value is determined by the cache control device 1 and thus, is a given value. Accordingly, the cost estimation unit 4 may estimate the memory cost based on the estimated request rate in each node. In the meantime, the estimated request rate is represented by the total of the reception rate and the propagation rate. For example, in the example illustrated in FIG. 8, the request rate of the node N4 is “r4.” Further, the request rate of the node N2 is “λ(2,4)+λ(2,5).”

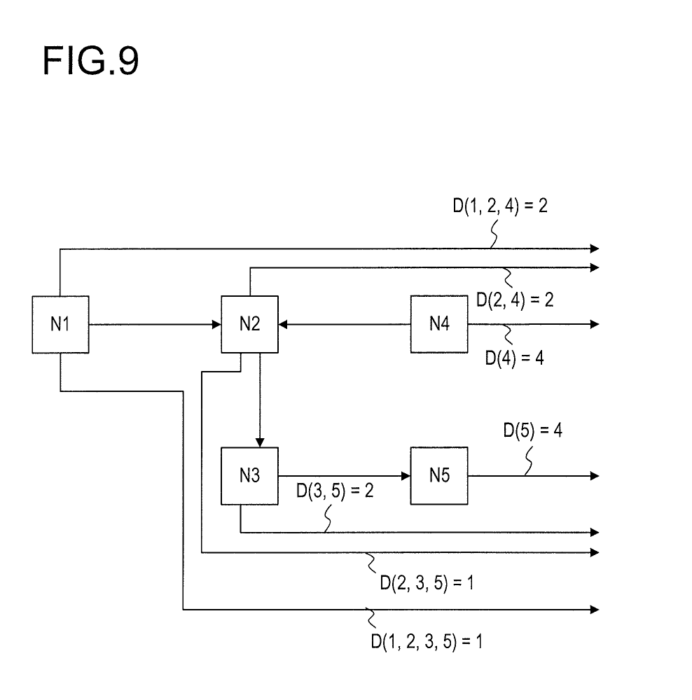

FIG. 9 is a diagram for explaining a delivery cost. In the meantime, the configuration of the distributed cache system illustrated in FIG. 8 is the same as that in FIG. 9. Further, the estimation of the delivery cost illustrated in FIG. 9 is performed using the estimation results for the request propagation illustrated in FIG. 8.

The total delivery cost is a total of the delivery costs for each route along which the content data is delivered. Here, in a case where the estimation results as illustrated in FIG. 8 are obtained, the cost estimation unit 4 estimates the delivery cost for seven delivery routes illustrated in FIG. 9. In FIG. 9, “D(i)” indicates a route along which the content data is delivered from the node Ni to the user due to the occurrence of the cache hit in the node Ni. The symbol “D(a, b, c, i)” indicates a delivery route along which the content data delivered from the node Na is transferred to the user via the nodes Nb, Nc, . . . Ni.

The delivery cost for each delivery route is expressed by the following equation. The “delivery cost=Cost_{b}H*K” indicates the reference delivery cost described above and is a constant given to the distributed cache system in advance. The “H” is the hop length of the route and is designated by the delivery tree root information. The “K” indicates the number of content data to be delivered (or the number of times of delivery). Here, the number of content data delivered from each node amounts to the number of times of the occurrence of cache hit in each node. Accordingly, for example, the node N4 delivers four content data to the user. Further, two content data are delivered from the node N1 to the user via the node N2 and the node N4. In the following description, the hop length H and the number of times of delivery for each delivery route are described as follows. D(4):H=1, K=4, D(2,4):H=2, K=2, D(1,2,4):H=3, K=2, D(5):H=1, K=4, D(2,5):H=2, K=2, D(2,3,5):H=3, K=1, D(1,2,3,5):H=4, K=1

The “Cost_{b}” and the “H” are given values. Since the “K” is calculated from the rate of received requests and the estimated cache hit ratio, the “K” is obtained from the estimation result by the request propagation estimation unit 3. That is, the cost estimation unit 4 may estimate the delivery cost of each delivery route based on the estimation result by the request propagation estimation unit 3.

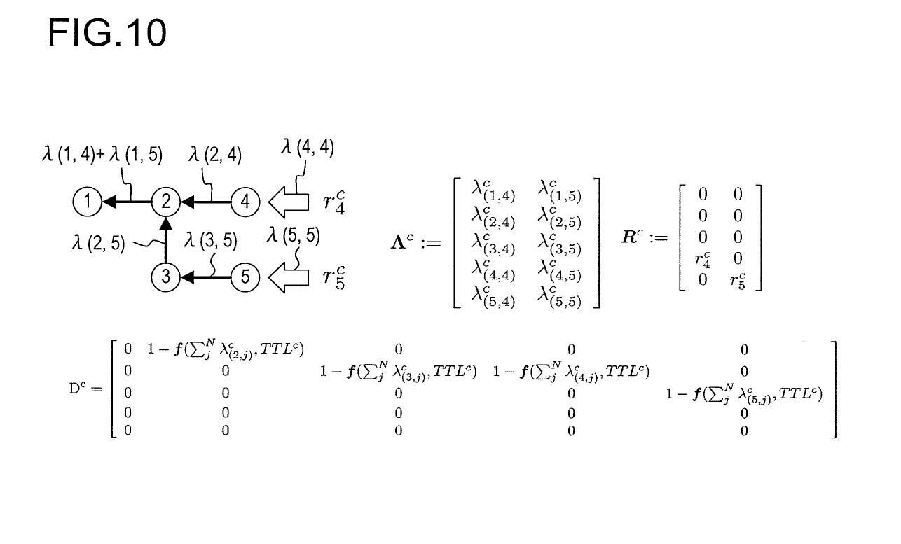

Next, descriptions will be made on the embodiment of the computation of estimating the request propagation with reference to FIG. 10. The request propagation is performed for each content. Therefore, subscript “c” may be attached in the equation described in the following in order to indicate that the computation is executed for each content.

The request propagation is expressed as the following Equation (3).

$${Λ}^{c} [ s + 1 ] = {D}^{c} [ s ] \cdot {Λ}^{c} [ s ] + {R}^{c} , ∀ c \\ {Λ}^{c} [ s ] := {[ \begin{matrix}{λ}_{( 1 , 1 )}^{c} [ s ] & … & {λ}_{( 1 , N )}^{c} [ s ] \\ ⋮ & ⋱ & ⋮ \\ {λ}_{( M , 1 )}^{c} [ s ] & … & {λ}_{( M , N )}^{c} [ s ]\end{matrix} ] \\ [ {R}^{c} ]}_{ij} = : \{ \begin{matrix}{r}_{j}^{c} , & ∀ i = reg\_site ( j ) \\ 0 & otherwise\end{matrix} \qquad ( 3 )$$

In Equation (3), a propagation request matrix Λ indicates a rate of requests propagated to each node. The propagation probability matrix D indicates the probability that the request may be transferred to the upper level node in each node. The reception matrix R indicates a reception rate of requests received from outside of the distributed cache system in each node. The “M” indicates the number of nodes within the distributed cache system. The “N” indicates the number of nodes that receive the requests from outside of the distributed cache system.

However, the propagation request matrix Λ is obtained by executing the repetitive operation in Equation (3). That is, the variable “s” indicates the number of times that the repetitive operation is executed in Equation (3). Also, the computation is repeated while incrementing the variable “s” by one until the variable “s” reaches the maximum hop length of the distributed cache system, such that each component of the propagation request matrix Λ is calculated. In the following, descriptions will be made on the computation of estimating the request propagation based on a model illustrated in FIG. 10. In the meantime, the model illustrated in FIG. 10 is substantially the same as the configuration of the embodiment illustrated in FIG. 8.

The distributed cache system includes five nodes 1, 2, 3, 4, and 5 illustrated in FIG. 10, that is, the “M” is five (M=5). Further, two nodes (node 4 and node 5) receive the request from outside of the distributed cache system, that is, the “N” is two (N=2). Accordingly, each of the propagation request matrix Λ and the reception matrix R is represented by 5×2 matrix (5 rows×2 columns). Further, the maximum hop length of the distributed cache system is four (4). In the present embodiment, the hop length from a certain node to the same node is stipulated as “1” for convenience. Accordingly, for example, the hop length from a certain node to a node adjacent thereto is “2.”

The propagation probability matrix D is represented by M×M matrix. That is, the propagation probability matrix D is represented by 5×5 matrix in the distributed cache system illustrated in FIG. 10. Each element of the propagation probability matrix D indicates the probability that the request may be transferred to the upper level node. That is, each element of the propagation probability matrix D indicates the cache miss ratio. In the meantime, the symbol “f” indicates the cache hit ratio and thus, the “1-f” indicates the cache miss ratio. Here, a column of the propagation probability matrix D corresponds to a transfer source node of the request and a row of the propagation probability matrix D corresponds to a transfer destination node of the request. For example, an element (1,2) of the propagation probability matrix D indicates the probability that the cache miss occurs in the node 2 and the request will be transferred to the node 1. Similarly, an element (2,3) of the propagation probability matrix D indicates the probability that the cache miss occurs in the node 3 and the request will be transferred to the node 2. An element (2,4) of the propagation probability matrix D indicates the probability that the cache miss occurs in the node 4 and the request will be transferred to the node 2. An element (3,5) of the propagation probability matrix D indicates the probability that the cache miss occurs in the node 5 and the request will be transferred to the node 3.2. In the meantime, other elements of the propagation probability matrix D are zeros.

The request propagation estimation unit 3 repetitively executes the computation of Equation (3) while incrementing the variable “s” as described above. Accordingly, the request propagation estimation unit 3 executes the computation of Equation (3) first for s=1. In this case, it is assumed that each element (that is, each request rate “λ”) of the propagation request matrix Λ[s=1] is zero. Further, the received rates “r4” and “r5” in the node 4 and node 5 are obtained by the measurement. Accordingly, “λ(4,4)=r4” and “λ(5,5)=r5” may be obtained in the propagation request matrix Λ[s+1=2]. Further, the cache miss ratios of the node 4 and node 5 are estimated according to the computation results. That is, the cache hit ratio in the node 4 is estimated based on the request rate “λ(4,4)” and the initial TTL value, and the cache hit ratio in the node 5 is estimated based on the request rate “λ(5,5)” and the initial TTL value. The cache hit ratio is estimated by, for example, Equation (1) described above.

The request propagation estimation unit 3 executes the computation of Equation (3) for s=2. That is, a multiplication of the request rate “λ(4,4)” of the node 4 with the cache miss ratio of the node 4 is computed such that the propagation rate “λ(2,4)” of the request directing from the node 4 to the node 2 is calculated. Similarly, a multiplication of the request rate “λ(5,5)” of the node 5 with the cache miss ratio of the node 5 is computed such that the propagation rate “λ(3,5)” of the request directing from the node 5 to the node 3 is calculated. Further, the cache miss ratios of the node 2 and node 3 are estimated according to the computation results. That is, the cache hit ratio in the node 2 is estimated based on the request rate “λ(2,4)” and the initial TTL value, and the cache hit ratio in the node 3 is estimated based on the request rate “λ(3,5)” and the initial TTL value.

The request propagation estimation unit 3 executes the computation of Equation (3) for s=3. That is, a multiplication of the request rate “λ(2,4)” of the node 2 with the cache miss ratio of the node 2 is computed such that the propagation rate “λ(1,4)” of the request directing from the node 4 to the node 1 via the node 2 is calculated. Similarly, a multiplication of the request rate “λ(3,5)” of the node 3 with the cache miss ratio of the node 3 is computed such that the propagation rate “λ(2,5)” of the request directing from the node 5 to the node 2 via the node 3 is calculated.

However, the node 2 may receive the requests from both of the node 4 and the node 3. Accordingly, the cache miss ratio in the node 2 is calculated based on a total of the propagation rate “λ(2,4)” of the request received from the node 4 and the propagation rate “λ(2,5)” of the request received from the node 5 via the node 3. Accordingly, the request propagation estimation unit 3 updates the cache hit ratio in the node 2 based on the request rate “λ(2,4)+λ(2,5)” and the initial TTL value.

The request propagation estimation unit 3 executes the computation of Equation (3) for s=4. That is, a multiplication of the request rate “λ(2,4)” of the node 2 with the cache miss ratio of the node 2 is computed such that the propagation rate “λ(1,4)” of the request directing from the node 4 to the node 1 via the node 2 is calculated. That is, the propagation rate “λ(1,4)” of the request directing from the node 4 to the node 1 via the node 2 is calculated based on the request rate “λ(2,4)” and the updated cache miss ratio of the node 2. Further, the propagation rate “λ(1,5)” of the request directing from the node 5 to the node 1 via the node 3 and the node 2 is calculated based on the request rate “λ(2,5)” and the updated cache miss ratio of the node 2. With this configuration, seven request rates “λ” are estimated. In the meantime, other elements of the propagation request matrix Λ are zeros.

The propagation probability matrix D is created based on the delivery tree root information. For example, it is defined that the node 1 is provided on the upper level side of the node 2 in the delivery tree root information. In this case, the cache miss ratio of the node 2 is set as an element specified by a row (e.g., first row) corresponding to the node 1 and a column (e.g., second column) corresponding to the node 2 in the propagation probability matrix D.

Next, descriptions will be made on the computation equation which estimates the total cost of the distributed cache system. The total cost is represented by the total of the memory cost and the delivery cost as described above. Accordingly, the total cost J of the content c is expressed by the following equation.

$${J}^{c} = {Cost}_{s} {θ}_{c} {\sum }_{i}^{M} f ( {\sum }_{k}^{N} {λ}_{( i , k )}^{c} , {TTL}^{c} ) + {Cost}_{b} [ 1 , … , 1 ] {( H * {Λ}^{c} )}^{T} [ \begin{matrix}f ( {\sum }_{k}^{N} {λ}_{( 1 , k )}^{c} , {TTL}^{c} ) \\ ⋮ \\ f ( {\sum }_{k}^{N} {λ}_{( M , k )}^{c} , {TTL}^{c} )\end{matrix} ] + {Cost}_{b} [ 1 , … , 1 ] {( H [ o , ] {Λ}^{c} [ o , ] )}^{T} ( 1 - f ( {\sum }_{k}^{N} {λ}_{( o , k )}^{c} , {TTL}^{c} ) ) \qquad ( 4 )$$

The “Costₛ” indicates the reference memory cost [cost/bit], the “Cost_{b}” indicates the reference delivery cost [cost/bit], the “θ_{c}” indicates the data size [bit] of the content c, and the “H” indicates the hop length matrix of the distributed cache system, “f” indicates the cache hit ratio function, and the “λ(i,k)” indicates the propagation rate of the request received from outside of the distributed cache system in the node k and propagated to the node i.

The propagation request matrix Λ is created by the request propagation estimation unit 3 as described above. Further, the hop length matrix “H” of the distributed cache system illustrated in FIG. 10 is represented by the hop length matrix “H”.

$$H := [ \begin{matrix}1 & 2 & 3 & 3 & 4 \\ 2 & 1 & 2 & 2 & 3 \\ 3 & 2 & 1 & 3 & 2 \\ 3 & 2 & 3 & 1 & 4 \\ 4 & 3 & 2 & 4 & 1\end{matrix} ] \qquad ( 5 )$$

In the meantime, the column of the hop length matrix “H” corresponds to the transfer source nod of the request and the row of the hop length matrix “H” corresponds to the transfer destination node of the request.

A first term of the right side of Equation (4) indicates the total memory cost. The total memory cost is represented by a multiplication of the reference memory cost, the data size, and the total cache hit ratio. The total cache hit ratio is a total of the cache hit ratios in each node.

A second term of the right side of Equation (4) indicates the delivery cost (or, a bandwidth cost). The delivery cost amounts to a total of the delivery costs for each delivery route. The delivery cost for each delivery route is represented by a multiplication of the reference delivery cost, the hop length, the request rate, and the cache hit ratio.

A third term of the right side of Equation (4) indicates the delivery cost when the cache miss occurs in the root node (e.g., the node 1 in the example illustrated in FIG. 10). In the meantime, when the cache miss occurs in the root node, the cache server provided in the root node acquires the content data from the content server and delivers the content data to the user.

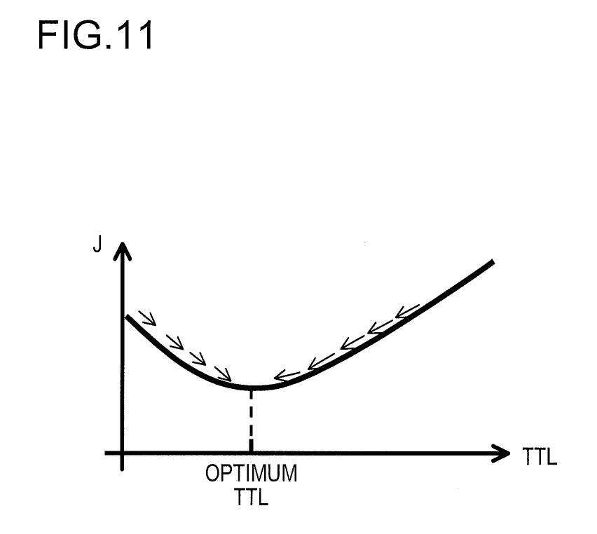

Next, descriptions will be made on the embodiment of a method of determining the initial TTL value. The initial TTL value is determined so as to reduce the total cost J estimated by the cost estimation unit 4. Here, the total cost J is a total of the memory cost and the delivery cost. Further, as described above, when the initial TTL value becomes larger, the memory cost becomes larger while the delivery cost becomes smaller. Accordingly, the total cost J includes a minimal value for a certain initial TTL value as illustrated in FIG. 11. Accordingly, the TTL determination unit searches for the initial TTL value which reduces the total cost J (e.g., the initial TTL value which makes the total cost J to become minimal).

The TTL determination unit determines the initial TTL value by a sweep search or an online search. In the sweep search, the total cost J is computed while sweeping the “TTL” over a predetermined range using Equation (4) described above. For example, the total cost J is computed at one-second intervals over a range of TTL spanning from one second to three hundreds seconds (e.g., TTL=1 second to 300 seconds). In this case, three hundreds of computation results may be obtained. Also, the TTL determination unit selects the initial TTL value which makes the total cost 3 to become minimal among three hundreds of calculation results.

As described above, the initial TTL value which makes the total cost J to become minimal is specified in the sweep search. Therefore, when the variation in the request rate is large, an appropriate initial TTL value may be specified for a short period of time using the sweep search. However, the sweep search causes a larger amount of operations of the TTL determination unit as compared to the online search.

In the online search, the initial TTL value which makes the total cost J to become minimal is searched for using the inclination (e.g., a differential) of the total cost J with respect to the initial TTL value. That is, in a case where the inclination of the total cost J is negative, it is determined that the initial TTL value which makes the total cost 3 to become minimal is larger than the current initial TIL value. In this case, the TTL determination unit makes the initial TTL value larger by Δt (e.g., one second). In the meantime, in a case where the inclination of the total cost J is positive, it is determined that the initial TTL value which makes the total cost 3 to become minimal is smaller than the current initial TTL value. In this case, the TTL determination unit makes the initial TTL value to be smaller by Δt. In the meantime, when the inclination of the total cost 3 is zero or substantially zero, it is determined that the current initial TTL value is the initial TTL value which makes the total cost 3 to become minimal. In this case, the TTL determination unit maintains the current initial TTL value.

The operation of the online search by the TTL determination unit is expressed by the following equation.

$${TTL}_{k + 1}^{c} = {TTL}_{k}^{c} + φ ( d {J}^{c} / d TTL ) \\ φ ( x ) = \{ \begin{matrix}0 & x = 0 \\ a & x < 0 \\ - a & x > 0\end{matrix} \qquad ( 6 )$$

The symbol “a” indicates a pre-designated time Δt and is, for example, one second.

The initial TTL value updated as described above is set in each node. Accordingly, when the TTL determination unit 5 updates the initial TTL value by the online search, the process of the flowchart illustrated in FIG. 6 is repetitively executed such that the initial TTL value gradually approaches the initial TTL value.

In the meantime, the initial TTL value is set in the cache memory for each content and the initial TTL value is updated for each content in the descriptions described above, but the present disclosure is not limited to the method described in the embodiment. For example, the present disclosure may be applied to a distributed cache system in which the initial TTL value is set for each service (e.g., a video streaming service and WEB service).

The operation for the online search in the distributed cache system in which the initial TTL value is set for each service is represented by the following equation.

$${TTL}_{k + 1}^{s} = {TTL}_{k}^{s} + φ ( {\sum }_{c ∈ {C}_{s}} d {J}^{c} / d TTL ) \\ φ ( x ) = \{ \begin{matrix}0 & x = 0 \\ a & x < 0 \\ - a & x > 0\end{matrix} \qquad ( 7 )$$

The symbol “Cs” indicates a set of contents that falls within a targeted service. That is, when the initial TTL value is updated for each service, the cache control device 1 estimates the total cost J for each content that falls within the targeted service and updates the initial TTL value based on a total of differentials of each total cost J.

As described above, the cache control device 1 estimates the cache hit ratio of each node and the propagation rate of the requests between the nodes based on the amount of requests arriving from outside of the distributed cache system. Further, the cache control device 1 determines the initial TTL value which reduces the total cost J for storing and delivering the content data (e.g., making the total cost J to become minimal) using the estimation results of the cache hit ratio and the request propagation rate. Also, the cache server of each node manages each content according to the TTL value determined by the cache control device 1. According to the configuration and method of the embodiments of the present disclosure, even in the distributed cache system in which the request propagation occurs due to the cache miss, the initial TTL value which reduces the total cost J may be determined.

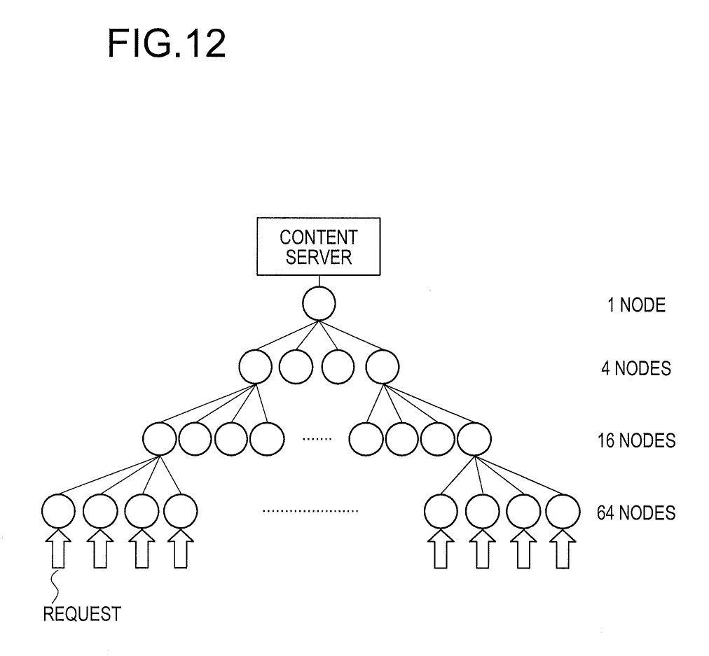

FIG. 12 illustrates a model of simulation by which the initial TTL value is derived. A single cache node (root node) is provided in a first layer in the distributed cache system for the simulation as illustrated in FIG. 12. The content server storing the content data is connected to the root node. Further, four cache nodes are connected to the lower level node of the root node. Each cache node of the second layer is connected with four cache nodes. That is, sixteen cache nodes are provided in a third layer. Each cache node of the third layer is connected with four cache nodes. That is, sixty four cache nodes are provided in a fourth layer. As described above, the distributed cache system for the simulation includes eighty five cache nodes.

The request from the user is received by the cache node of the fourth layer. The distribution of requests follows Zipf(1.2) distribution. The reference memory cost “Costₛ” is 0.03 and the reference delivery cost “Cost_{b}” is 0.97. The data size of content is “1.”

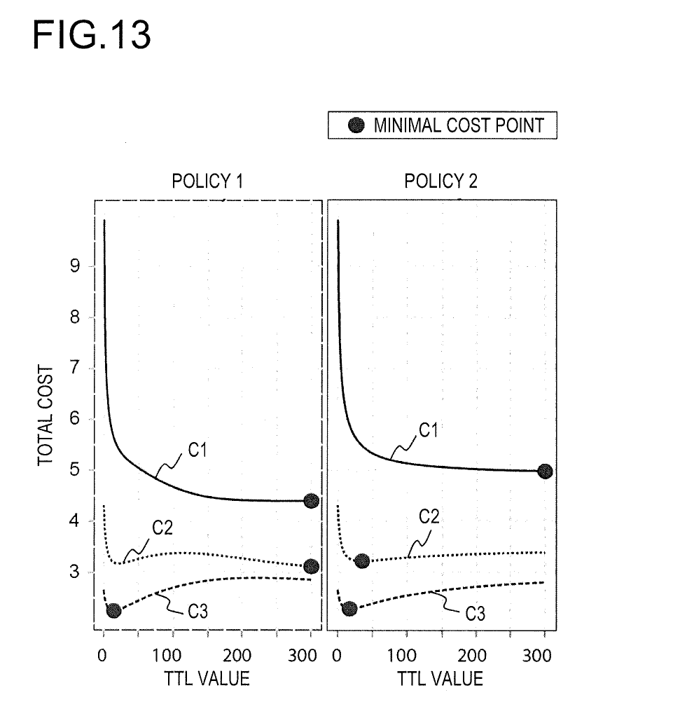

FIG. 13 illustrates a simulation result by a sweep search. Here, simulation is performed for the policy 1 illustrated in FIG. 3A and the policy 2 illustrated in FIG. 3B. Further, in the sweep search, the total cost 3 is computed at one-second intervals over a range of the initial TTL value spanning from one second to three hundreds seconds (e.g., initial TTL value=1 second to 300 seconds) for three contents (C1, C1, and C3). Also, the initial TTL value which makes the total cost J to become minimal.

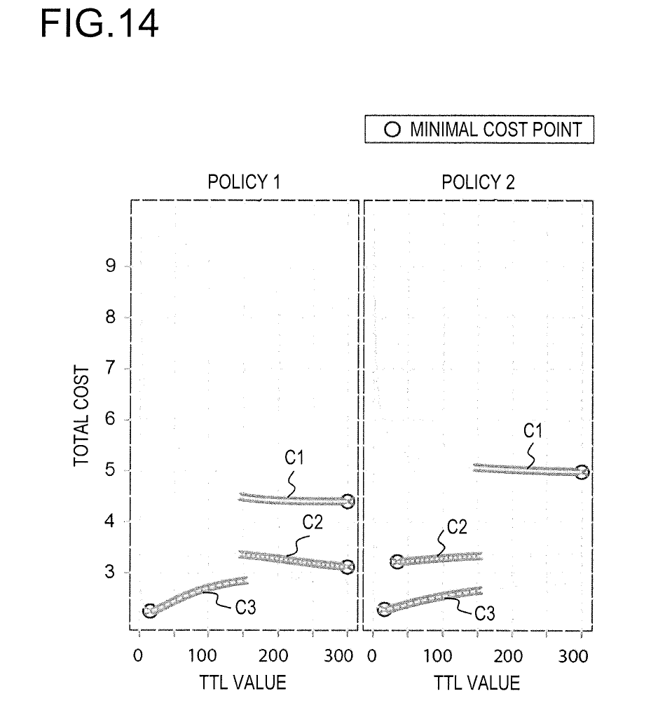

FIG. 14 illustrates a simulation result by an online search. In the online search, searching is started at an initial TIL value of 150 seconds (e.g., initial TTL value=150 seconds). That is, it is assumed that, an initial TIL value of 150 seconds is set for each cache node at the time of starting the simulation. Also, the cache control device 1 first acquires the request information which indicates the rate of received requests of each cache node. Also, the cache control device 1 computes the total cost J based on the collected request information and also computes the inclination of the total cost J. Here, for example, the inclination of the total cost J for the content C1 is negative. In this case, the cache control device 1 sets an initial TIL value of 151 seconds (e.g., initial TTL value=151 seconds) to each cache node by adding “Δt=1” to the current initial TTL value.

Next, the cache control device 1 acquires the request information which indicates the rate of received requests of each cache node. Further, the cache control device 1 computes the total cost J based on the collected request information and also computes the inclination of the total cost J. Also, the cache control device 1 update the initial TTL value based on the inclination of the total cost J. Thereafter, the cache control device 1 regularly executes the process described above.

### Other Embodiment

In the embodiments described above, the cache control device 1 provided for the distributed cache system determines the optimum initial TTL value. However, the present disclosure is not limited to the configuration described above. For example, the present disclosure may have a configuration in which the propagation request rate and the cost are estimated in each node and the estimation results are transmitted to the upper level nodes, respectively. In this case, the initial TTL value is determined at the upper most level node (e.g., the root node).

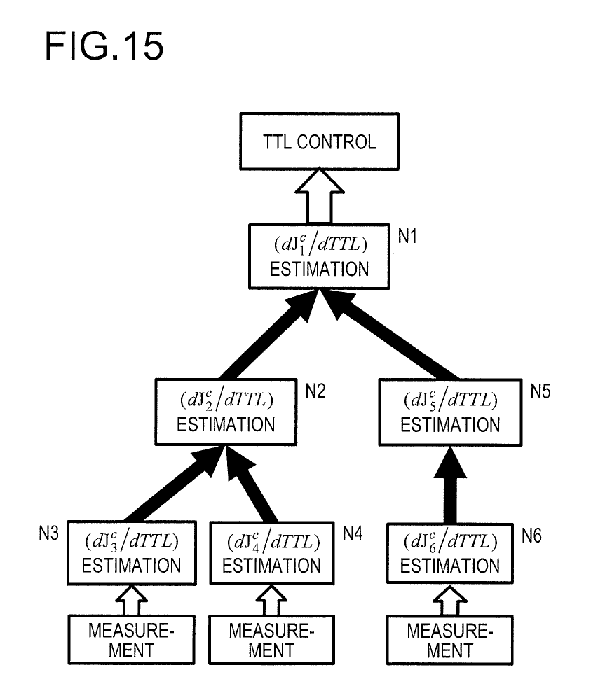

FIG. 15 is a diagram for explaining a method of determining the initial TTL value by other embodiment. In the present embodiment, the distributed cache system includes the node 1, node 2, node 3, node 4, node 5, and node 6. The node 1 is the root node. The nodes 2 and 5 are connected to the lower level side of the node 1, the nodes 3 and 4 are connected to the lower level side of the node 2, and the node 6 is connected to the lower level side of the node 5. The nodes 3, 4, and 6 receive the request from outside of the distributed cache system.

In this case, the rate of received requests is measured at an edge node of the distributed cache system. That is, each of the nodes 3, 4, and 6 measures the amount of requests received from outside of the distributed cache system.

Each of the nodes 3, 4, and 6 estimates the amount of requests transferred to the upper level node due to the cache miss and the cost value of its own node based on the current initial TTL value and the measured request rate, and also computes the differential of the estimated cost value. The cost value includes the memory cost and the delivery cost. For example, the node 3 estimates the propagation rate “λ(2,3)” of requests transferred from the node 3 to the node 2, and the cost J₃ of the node 3 to compute the differential “dJ₃/dTTL” of the cost. Also, each of the nodes 3, 4, and 6 notifies the upper level node of the estimation result and the computed result.

Each of the nodes 2 and 5 estimates the amount of requests transferred to the upper level node due to the cache miss and the cost value of its own node based on the current initial TTL value and the information notified from the lower level node, and also computes the differential of the estimated cost value. For example, the node 2 estimates the propagation rate “λ(1,3)” of the requests transferred from the node 3 to the node 1 via the node 2 based on the current initial TTL value and the propagation request rate “λ(2,3)” notified from the node 3. Further, the node 2 estimates the propagation rate “λ(1,4)” of the requests transferred from the node 4 to the node 1 via the node 2 based on the current initial TTL value and the propagation request rate “λ(2,4)” notified from the node 4. Further, the node 2 estimates the “cost J₂” and computes the differential “dJ₃/dTTL” of the cost. Also, each of the nodes 2 and 5 notifies the upper level node of the estimation result and the computation result. Further, each of the nodes 2 and 5 transfers the differential of the cost received from the lower node to the upper level node.

The node 1 estimates the cost value of the node 1 based on the current initial TTL value and the information notified from the nodes 2 and 5, and computes the differential of the cost value. Also, the node 1 computes the total sum of differentials of the computed cost value at each node (including the node 1). That is, the following computation is executed.

dJ^{c}/dTTL=ΣₘdJₘ^{c}/dTTL (8)

Further, the node 1 updates the initial TTL value based on the total sum of the node 1. That is, the following computation is executed.

TTLₖ₊₁^{c}=TTLₖ^{c}+φ(dJ^{c}/dTTL) (9)

Also, the node 1 notifies each node of the updated initial TTL value.

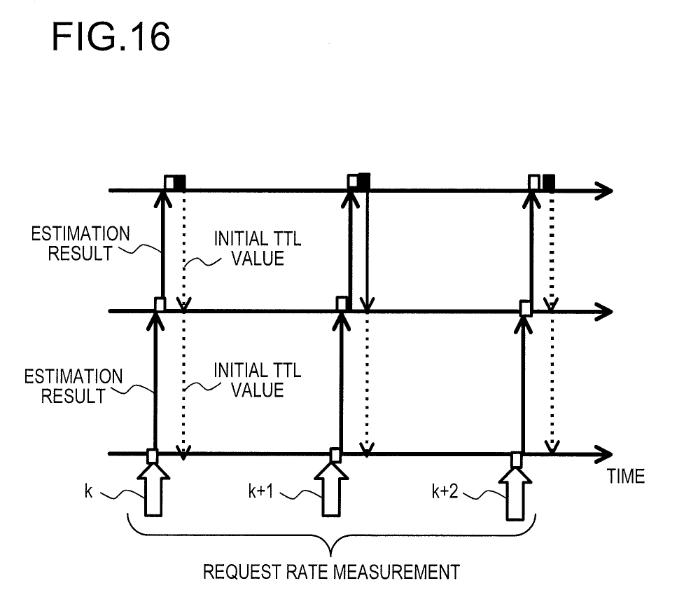

FIG. 16 illustrates a sequence of determining the initial TTL value by other embodiment. In other embodiment, the initial TTL value is updated at designated control intervals. The control interval is not particularly limited but may be, for example, 10 seconds. Each edge node measures the request rate at the control intervals, and estimates, for example, the request propagation rate and the cost as illustrated in FIG. 16. Further, the estimation result for each node is notified toward the upper level node of the delivery tree. Also, the root node collects the estimation result for all nodes and updates the initial TTL value using the estimation results. The updated initial TTL value is set one by one sequentially from the upper level node of the delivery tree toward the lower level node.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A cache control device comprising:
a processor configured to execute a procedure, the procedure comprising:
collecting request information for indicating an amount of request received by each of a plurality of nodes from outside of a distributed cache system in which a cache memory is provided in each of the plurality of nodes hierarchically connected with each other and the request is transferred to an upper level node of a delivery tree route in the plurality of nodes when a cache miss occurs for the request;
estimating, by a request propagation estimation unit, a propagation amount of the request transferred within the distributed cache system due to the cache miss based on the request information, an initial TTL (Time-To-Live) value set in the plurality of nodes indicating a time during which data is stored in the cache memory, and delivery tree root information for indicating the delivery tree route;
estimating, by a cost estimation unit, a total cost for storing and delivering data corresponding to the request based on the propagation amount of the request estimated by the request propagation estimation unit, memory cost information for indicating a cost required for storing and delivering a predetermined amount of data, and delivery cost information for indicating a cost required for transferring the predetermined amount of data; and
updating, by a TTL determination unit, the initial TTL value so as to reduce the total cost estimated by the cost estimation unit,
wherein the cache control device and the plurality of nodes are included in the distributed cache system.

2. The cache control device according to claim 1, wherein
when a first node in the plurality of nodes receives the request at a first rate from outside of the distributed cache system,
the request propagation estimation unit estimates a cache miss ratio in the first node based on a current initial TTL value and the first rate, and estimates a second rate indicating a propagation rate of the request transferred from the first node to a second node in the plurality of nodes connected to an upper level node of the first node based on the first rate and the cache miss ratio in the first node.

3. The cache control device according to claim 2, wherein the request propagation estimation unit estimates a cache miss ratio in the second node based on the current initial TTL value and the second rate, and estimates a third rate indicating a propagation rate of the request transferred from the second node to a third node in the plurality of nodes connected to an upper level node of the second node based on the second rate and the cache miss ratio in the second node.

4. The cache control device according to claim 1, wherein
the cost estimation unit computes a total cost value for each of a plurality of initial TTL values that fall within a predetermined range, and
the TTL determination unit selects an initial TTL value corresponding to a minimal total cost value among a plurality of total cost values computed by the cost estimation unit and updates the current initial TTL value to the selected initial TTL value.

5. The cache control device according to claim 1, wherein the TTL determination unit updates the initial TTL value based on an inclination of the total cost with respect to the current initial TTL value.

6. The cache control device according to claim 5, wherein the TTL determination unit makes the initial TTL value to be larger than the initial TTL value by a predetermined amount when the inclination of the total cost is negative, and makes the initial TTL value to be smaller than the initial TTL value by a predetermined amount when the inclination of the total cost is positive.

7. A cache control method, by a processor, comprising:
collecting request information for indicating an amount of request received by each of a plurality of nodes from outside of a distributed cache system in which a cache memory is provided in each of the plurality of nodes hierarchically connected with each other and the request is transferred to an upper level node of a delivery tree route in the plurality of nodes when a cache miss occurs for the request;
estimating, by a request propagation estimation unit, a propagation amount of the request transferred within the distributed cache system due to the cache miss based on the request information, an initial TTL (Time-To-Live) value set in the plurality of nodes indicating a time during which data is stored in the cache memory, and delivery tree root information for indicating the delivery tree route;
estimating, by a cost estimation unit, a total cost for storing and delivering data corresponding to the request based on the propagation amount of the request estimated by the request propagation estimation unit, memory cost information for indicating a cost required for storing and delivering a predetermined amount of data, and delivery cost information for indicating a cost required for transferring the predetermined amount of data, and
updating the initial TTL value so as to reduce the total cost estimated by the cost estimation unit.

8. A cache control method in a distributed cache system in which a cache memory is provided in each of a plurality of nodes hierarchically connected with each other and request is transferred to an upper level node of a delivery tree route in the plurality of nodes when a cache miss occurs for the request, the cache control method comprising:
estimating a propagation amount of the request notified from a lower level node in the plurality of nodes;
estimating a propagation amount of the request to the upper level node and a cost for storing and delivering data corresponding to the request, based on a current initial TTL (Time-To-Live) value and the estimated propagation amount of the request notified from the lower level node;
notifying the corresponding upper level node of each of node cost information for indicating the estimated cost for storing and delivering data and node request information for indicating the estimated propagation amount of the request in each node, based on delivery tree root information for indicating the delivery tree route; and
updating the initial TTL value based on the node request information and the node cost information notified from each node in a node located at a topmost position in the delivery tree route.
